(19) United States
(12) Patent Application Publication
(10) Pub. No.: US 2008/0114773 A1
(43) Pub. Date: May 15, 2008

(54) Apparatus and method for prefetching web page

(75) Inventors: Seung-hak Choi, Seongnam-si (KR); Hyo Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/785,834

(22) Filed: Apr. 20, 2007

(30) Foreign Application Priority Data
Nov. 9, 2006 (KR) 10-2006-0110537

(51) Int. Cl. G06F 17/30

(52) U.S. Cl. 707/10; 707/E17.119

(57) ABSTRACT

A web page prefetching apparatus and method for efficiently prefetching a web page using link class information indicating preference of client devices for links contained in a web page. A client device includes a user input unit receiving a user input signal for a web page request; a controller receiving a first web page provided by a first web server based on a user input signal requesting the first web page, requesting a second web page provided by a second web server from the second web server, which is determined based on link class information indicating the preference of client devices for links contained in the first web page, without a user input signal, and receiving the second web page from the second web server; and a storage unit storing the second web page. Accordingly, since the reliability and efficiency of prefetching can be increased, prefetched web pages can be quickly provided to a user.

### CROSS-REFERENCE TO RELATED PATENT APPLICATION

This application claims the benefit of Korean Patent Application No. 10-0110537, filed on Nov. 9, 2006, in the Korean Intellectual Property Office, the disclosure of which is incorporated herein in its entirety by reference.

### BACKGROUND OF THE INVENTION

1. Field of the Invention

The present invention relates to an apparatus and method for prefetching a web page, and more particular, to a web page prefetching apparatus and method for efficiently prefetching a web page using link class information indicating a preference of client devices for links contained in a web page.

2. Description of the Related Art

If a user inputs a Uniform Resource Locator (URL) to a web browser, the web browser determines which server on the Internet hosts the web page corresponding to the URL, and downloads the web page from that server. The web browser determines the layout of the web page by analyzing the language, such as HyperText Markup Language (HTML), of the web page, and then renders and provides the web page to the user.

The longest delay between inputting the URL and rendering the web page is caused by downloading the web page from the server. This is usually because communication between the server and the web browser takes place over a relatively low-speed network.

### SUMMARY OF THE INVENTION

The present invention provides a web page prefetching apparatus and method for prefetching a highly preferred web page using link class information indicating a preference of client devices for links contained in a web page.

According to an aspect of the present invention, there is provided a client device prefetching a web page via the Internet, the client device comprising: a user input unit receiving a user input signal for a web page request; a controller receiving a first web page provided by a first web server based on a user input signal requesting the first web page, requesting a second web page provided by a second web server from the second web server, which is determined based on link class information indicating the preference of client devices for links contained in the first web page, without any user input signal, and receiving the second web page from the second web server; and a storage unit storing the second web page.

The controller may provide the stored second web page if a user input signal requesting the second web page is received.

The controller may transmit to the first web server information indicating that the client device has requested the second web page from the second web server using information on the first web page.

The link class information may be generated by the first web server based on a frequency of link use, which indicates how often client devices have requested other web pages by selecting each of the links contained in the first web page.

The controller may receive the link class information from the first web server.

The controller may transmit to the first web server path information indicating a path used until the client device accesses the first web server, wherein the link class information is generated based on the path information.

The link class information may be generated by the client device analyzing a web page.

The second web server may provide a web page acquired through a link having the highest class in the link class information.

The controller may acquire link class information indicating preference of the client devices for links contained in the second web page.

The controller may receive from the first web server the link class information, which has been received by the first web server from a web server providing an Internet portal site providing an information search service or from a link class management server collecting and managing class information of links to web servers.

The client device may further comprise an output unit outputting a received web page, wherein the controller controls the output unit to display the first web page so that a predetermined number of links having a higher class in the link class information are distinguished from the remaining links contained in the first web page.

According to another aspect of the present invention, there is provided a method of prefetching a web page via the Internet in a client device, the method comprising: requesting a second web page provided by a second web server from the second web server, which is determined based on link class information indicating the preference of client devices for links contained in a first web page provided by a first web server; receiving the first web page from the first web server and providing the first web page; and receiving the second web page from the second web server.

According to another aspect of the present invention, there is provided a computer readable recording medium storing a computer readable program for executing a method of prefetching a web page via the Internet in a client device, the method comprising: requesting a second web page provided by a second web server from the second web server, which is determined based on link class information indicating the preference of client devices for links contained in a first web page provided by a first web server; receiving the first web page from the first web server and providing the first web page; and receiving the second web page from the second web server.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a web page prefetching system according to an embodiment of the present invention;

FIG. 2 is a signaling diagram illustrating communication between a client device, a first web server, and a second web server, in the web page prefetching system illustrated in FIG. 1, according to an embodiment of the present invention;

FIG. 3 is a signaling diagram for describing a process of generating link class information according to an embodiment of the present invention;

FIG. 4 is a block diagram for describing a process of generating link class information according to another embodiment of the present invention; and

FIG. 5 is a flowchart illustrating a method of prefetching a web page according to an embodiment of the present invention.

### DETAILED DESCRIPTION OF THE INVENTION

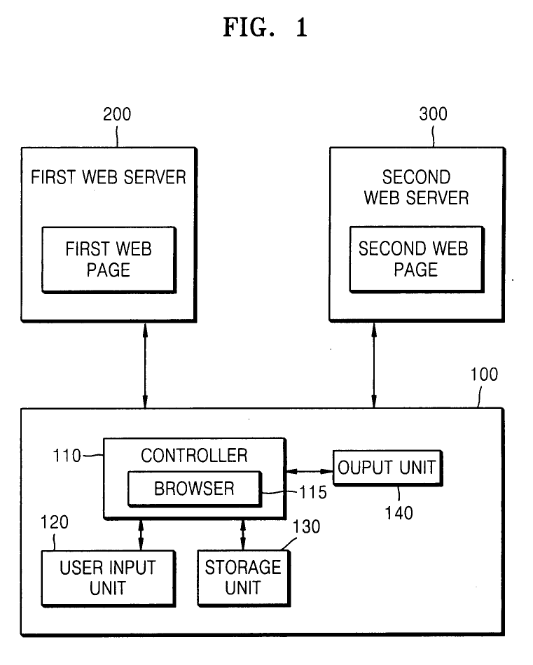

FIG. 1 is a block diagram of a web page prefetching system according to an embodiment of the present invention.

Referring to FIG. 1, the web page prefetching system includes a client device 100, a first web server 200, and a second web server 300, connected to each other via the Internet. The client device 100 includes a controller 110, a user input unit 120, a storage unit 130, and an output unit 140.

The controller 110 includes a web browser 115 for requesting data from web servers on the Internet, receiving the data, and providing the data to a user. The controller 110 controls data communication between the components included in the client device 100, and controls the general operation of the client device 100.

The user input unit 120 receives a user input signal and provides the received user input signal to the controller 110, so that the controller 110 operates according to the user input signal.

The storage unit 130 stores web pages received via the Internet.

The output unit 140 outputs a web page analyzed and processed by the web browser 115.

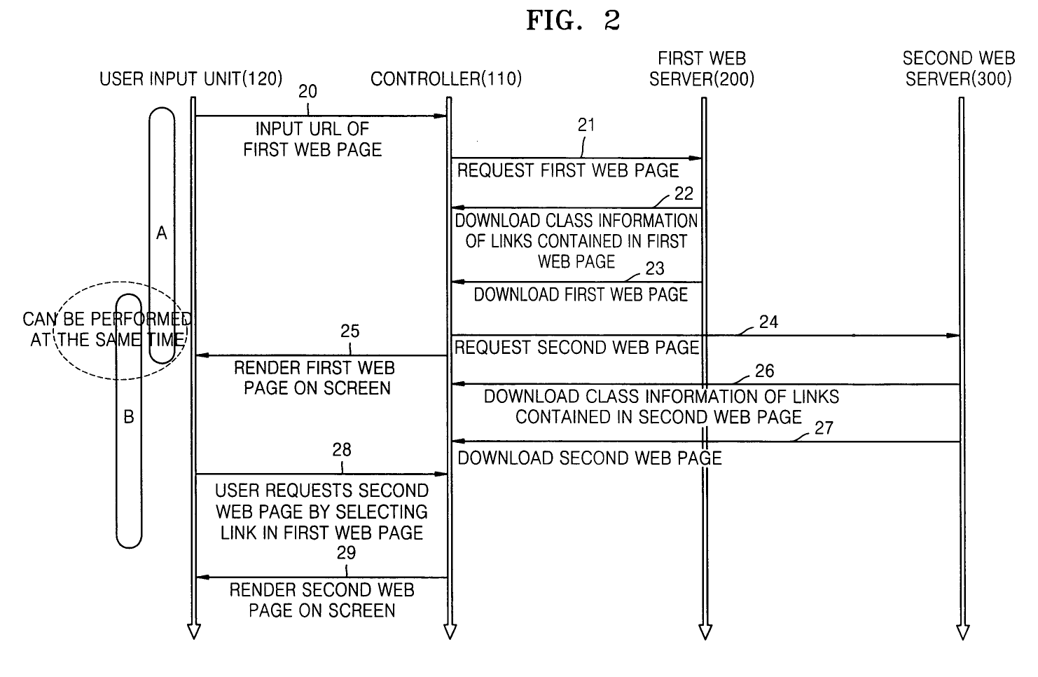

FIG. 2 is a signaling diagram illustrating communication between the client device 100, the first web server 200, and the second web server 300, in the web page prefetching system illustrated in FIG. 1, according to an embodiment of the present invention. A method of prefetching a web page according to an embodiment of the present invention will now be described with reference to FIGS. 1 and 2.

If the user inputs a Uniform Resource Locator (URL) of a first web page into the user input unit 120 in operation 20, to request the first web page, the controller 110 (or the web browser 115) requests the first web page from the first web server 200 in operation 21. The controller 110 downloads class information on the links contained in the first web page from the first web server 200 in operation 22, and downloads the first web page in operation 23.

A web page link provides a selective connection to another web page from a word, an image, or an information object. The link class information indicates a preference of client devices for links contained in a web page provided by a web server. The link class information indicates a class of each link, and the class can be represented with a number or any other form. For example, if a link A and a link B are contained in a web page, link class information may be 0.4 for link A and 0.7 for link B, and the greater number may indicate the higher class.

The controller 110 can acquire the link class information indicating a preference of client devices for the links contained in the first web page, and prefetch another web page based on the acquired link class information. If it is assumed in FIG. 2 that the web page corresponding to the link having the highest class in the link class information is a second web page, the controller 110 requests the second web page from the second web server 300 in operation 24. Operations 23 and 24 may be performed at the same time.

The controller 110 renders the first web page and outputs it to the output unit 140 in operation 25. At the same time, the controller 110 downloads class information of links contained in the second web page provided by the second web server 300 in operation 26, downloads the second web page in operation 27, and stores the second web page in the storage unit 130. Although not shown in FIG. 2, the controller 110 can request a web page from a web server which provides another web page determined based on the link class information of the second web page, and download the web page, before the user requests the web page.

If the user requests the second web page in operation 28 by selecting a link connected to the second web page from among the links contained in the first web page output to the output unit 104, the controller 110 provides the second web page to the user in operation 29 by reading the second web page from the storage unit 130, rendering the second web page, and outputting the second web page to the output unit 104. In this case, the controller 110 controls the output unit 104 to display the first web page so that a predetermined number of links having a higher class in the link class information are distinguished from the remaining links contained in the first web page. Thus, if the user wishes to view another web page linked to by the first web page, the user can easily recognize links which have a higher access frequency due to a preference of other client devices which have used the first web page, using the client device 100.

As described above, when the client device 100 according to an embodiment of the present invention receives the first web page from the first web server 200, the client device 100 also requests the second web page from the second web server 300, which is determined based on the class information on the links contained in the first web page, and receives the second web page from the second web server 300. Thus, without any user input signal, the client device 100 downloads the second web page, which is determined to have the highest preference of client devices since the second web page has the highest class in the link class information indicating the preference of the client devices for the links contained in the first web page, and when the user requests the second web page, the client device 100 can provide the second web page to the user without a time delay by outputting the stored second web page. In particular, as illustrated in FIG. 2, since the procedures of processing the first web page and the second web page can be performed at the same time, the client device 100 can quickly provide a web page to the user.

The process of prefetching a web page from the second web server 300 when the second web server 300 is a web server providing a web page corresponding to the link having the highest class in the link class information of the first web page has been described. However, the controller 110 may prefetch web pages in the order of link class from a predetermined number of web servers, providing the web pages corresponding to a predetermined number of links having higher classes in link class information, and store the prefetched web pages.

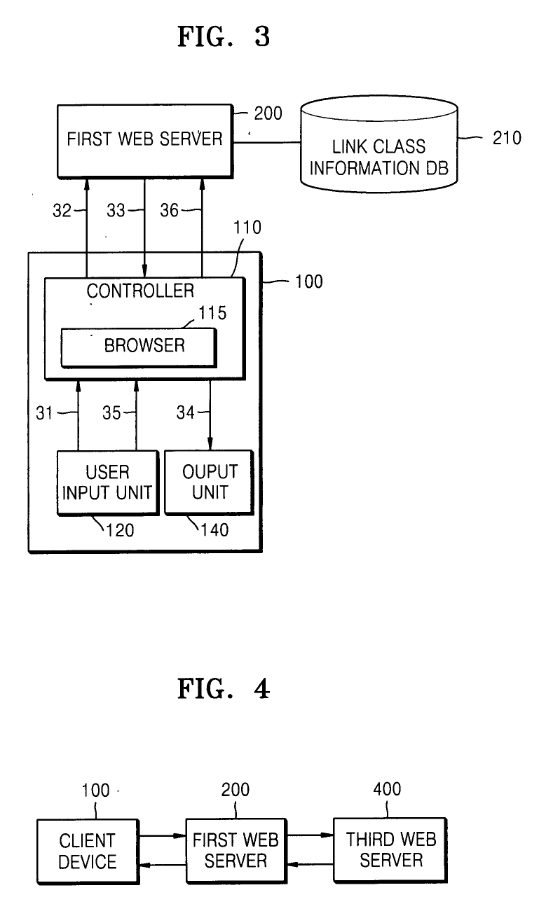

FIG. 3 is a signaling diagram for describing a process of generating link class information according to an embodiment of the present invention.

Referring to FIG. 3, if the user inputs a URL of a first web page into the user input unit 120 in operation 31, the controller 110 requests the first web server 200 corresponding to the URL for the first web page requested by the user in operation 32. The controller 110 downloads class information of the links contained in the first web page from the first web server 200, and downloads the first web page from the first web server 200 in operation 33. The controller 110 renders the first web page and outputs the first web page to the output unit 140 in operation 34. At the same time, the controller 110 requests a second web server (not shown) for a second web page having the highest preference of client devices based on the link class information, and receives the second web page.

If the user inputs a user input signal for selecting a link to the second web page, which is contained in the first web page, in operation 35, the controller 110 transmits to the first web server 200 information indicating that the controller 110 has requested the second web page provided by the second web server using information on the first web page, in operation 36.

The first web server 200 generates link class information using the information indicating that the controller 110 has requested the second web page provided by the second web server using the information on the first web page, and stores the link class information in a link class information database (DB) 210. In addition, the first web server 200 generates link class information based on the frequency of selection of each link, which indicates how often all client devices (including the client device 100) obtaining information on other web pages through the first web server 200 have requested the other web pages by selecting the links contained in the first web page.

The controller 110 may transmit to the first web server 200 path information indicating a path used before the client device 100 accesses the first web server 200, as well as the information indicating the request frequency. In this case, the link class information is generated based on the information indicating the request frequency and the path information.

For example, link class information in the case where the client device 100 accesses the first web page through a web page A may be different from link class information in the case where the client device 100 accesses the first web page through a web page B. That is, the request frequency of a web page C related to the web page A, which has been selected by client devices which have accessed the first web page through the web page A, may be higher than the request frequency of other web pages linked on the first web page, and the request frequency of a web page D related to the web page B, which has been selected by client devices which have accessed the first web page through the web page B, may be higher than the request frequency of other web pages linked on the first web page. Thus, when link class information is generated using path information, a plurality of link class information for the first web page may exist according to the path information.

If it is assumed that the first web page contains a link 1_{—}1, a link 1_{—}2, and a link 1_{—}3, link class information may data as illustrated in Table 1.

TABLE 1

| Path | Link | Link | Link |
|---|---|---|---|
| information | 1_1 | 1_2 | 1_3 |
| Web page A | 0.4 | 0.3 | 0.3 |
| Web page B | 0.1 | 0.2 | 0.7 |

In Table 1, it is assumed that the link 1_{—}1 indicates a link from the first web page to the second web page, the link 1_{—}2 indicates a link from the first web page to a third web page, and the link 1_{—}3 indicates a link from the first web page to a fourth web page. In the case of the link class information illustrated in Table 1, when the client device 100 has accessed the first web page through the web page A, since the class of the link 1_{—}1 is the highest, the client device 100 can prefetch the second web page. When the client device 100 has accessed the first web page through the web page B, since the class of the link 1_{—}3 is the highest, the client device 100 can prefetch the fourth web page.

In order to maintain the link class information reliably based on user preference, the first web server 200 can update the link class information every time frequency information and path information of a request for another web page is received from client devices.

FIG. 4 is a block diagram describing a process of generating link class information according to another embodiment of the present invention.

While FIG. 3 illustrates that the first web server 200 generates and manages the link class information, the first web server 200 can receive the link class information from a third web server 400 which collects and manages the link class information, and then transmit the link class information to the client device 100.

The third web server 400 may be a web server providing an Internet portal site providing an information search service, or a link class management server collecting and managing class information of links to web servers. If the link class information is received from a server providing an Internet portal site or a server dedicated to managing only link class information, the reliability of the link class information can be increased, and the efficiency of prefetching web pages increases.

According to another embodiment of the present invention, link class information can be generated by analyzing a web page in the client device 100. When information on a link selection frequency is contained in the web page, the client device 100 can generate link class information using the information contained in the web page, without separately receiving the link class information from a web server. For example, if the first web page provides information of a bulletin board type, and if search frequency information regarding each of the articles constituting the bulletin board is contained in the first web page, the client device 100 can generate link class information using the search frequency information.

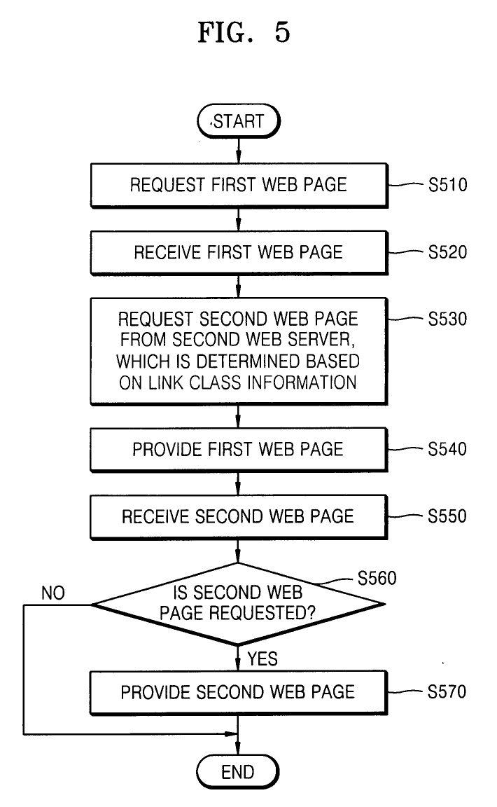

FIG. 5 is a flowchart illustrating a method of prefetching a web page according to an embodiment of the present invention.

The client device 100 requests a first web page from the first web server 200 in operation S510, and receives the first web page from the first web server 200 in operation S520. The client device 100 requests a second web page from the second web server 300, which is determined based on link class information indicating the preference of client devices for links contained in the first web page, in operation S530.

The link class information may be generated by the first web server 200 based on the selection frequency of each of the links, which indicates how often client devices have requested other web pages by selecting the links contained in the first web page, and received by the client device 100. Alternatively, client devices may transmit frequency information and path information of a request for other web pages through the first web page to the first web server 200, and the first web server 200 may generate the link class information using the received information.

Alternatively, the link class information may be received by the first web server 200 from a web server providing an Internet portal site providing an information search service, or a link class management server collecting and managing class information of links to web servers existing in the Internet, and received by the client device 100 from the first web server 200 before or after the first web page is received by the client device 100 from the first web server 200. Alternatively, the client device 100 may generate the link class information by analyzing the first web page in the middle of operations S520 and S530.

The client device 100 provides the first web page through the output unit 140 in operation S540. The client device 100 displays the first web page so that a predetermined number of links having a higher class in the link class information are distinguished from the remaining links contained in the first web page.

If the class of a link to the second web page provided by the second web server 300 is the highest in the link class the client device 100 requests the second web page from the second web server 300, receives the second web page from the second web server 300, and stores the second web page in operation S550. The second web server 300 may transmit link class information contained in the second web page to the client device 100 before or after the second web server 300 transmits the second web page to the client device 100, and the client device 100 may prefetch a web page having the highest class based on the link class information contained in the second web page received from the second web server 300. The link class information of the second web page also can be generated using the methods described above.

If a user input signal for requesting the second web page is input in operation S560, the client device 100 outputs the stored second web page in operation S570. In operation S570, the client device 100 displays the second web page so that a predetermined number of links having a higher class in the link class information are distinguished from the remaining links contained in the second web page.

The invention can also be embodied as computer readable code on a computer readable recording medium. Also, functional programs, code, and code segments for accomplishing the present invention can be easily created by programmers skilled in the art to which the present invention pertains. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and flash memory. The computer readable recording medium can also be distributed over network coupled computer systems so that the computer readable code is stored and executed in a distributed fashion.

As described above, according to the present invention, a web page preferred by users can be prefetched using link class information indicating the preference of client devices for links contained in another web page. Thus, by prefetching a web page connected through a link having a higher preference by users, the reliability and efficiency of prefetching can be increased, and prefetched web pages can be quickly provided to a user.

In addition, by displaying a web page to the user so that links having a higher class, which are determined based on the link class information, are distinguished from the remaining links, the user can easily recognize links having a higher preference in the web page.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A client device prefetching a web page via the Internet, the client device comprising:
a user input unit receiving a user input signal for a web page request;
a controller receiving a first web page provided by a first web server based on a user input signal for requesting the first web page, and requesting, without a user input signal, a second web page provided by a second web server from the second web server, is the second web page being determined based on link class information indicating preference of client devices for links contained in the first web page, and receiving the second web page from the second web server; and
a storage unit storing the second web page.

2. The client device of claim 1, wherein the controller provides the stored second web page if a user input signal requesting the second web page is received.

3. The client device of claim 1, wherein the controller transmits to the first web server information indicating that the client device has requested the second web page from the second web server using information on the first web page.

4. The client device of claim 1, wherein the link class information is generated by the first web server based on a selection frequency of each of the links, which indicates how often client devices have requested other web pages by selecting each of the links contained in the first web page.

5. The client device of claim 1, wherein the controller receives the link class information from the first web server.

6. The client device of claim 1, wherein the controller transmits to the first web server path information indicating a path used before the client device accesses the first web server,
wherein the link class information is generated based on the path information.

7. The client device of claim 1, wherein the link class information is generated by the client device analyzing a web page.

8. The client device of claim 1, wherein the second web server provides a web page acquired through a link having the highest class in the link class information.

9. The client device of claim 1, wherein the controller acquires link class information indicating preference of client devices for links contained in the second web page.

10. The client device of claim 1, wherein the controller receives from the first web server the link class information, which has been received by the first web server from a web server providing an Internet portal site providing an information search service or from a link class management server collecting and managing class information of links to web servers.

11. The client device of claim 1, further comprising an output unit outputting a received web page,
wherein the controller controls the output unit to display the first web page so that a predetermined number of links having a higher class in the link class information are distinguished from the remaining links contained in the first web page.

12. A method of prefetching a web page via the Internet in a client device, the method comprising:
requesting a first web page; prefetching a second web page provided by a second web server from the second web server, which is determined based on link class information indicating the preference of client devices for links contained in the first web page provided by a first web server;
receiving the first web page from the first web server and providing the first web page; and
receiving the second web page from the second web server.

13. The method of claim 12, further comprising providing the second web page if a user input signal requesting the second web page is received.

14. The method of claim 12, further comprising transmitting to the first web server information indicating that the client device has requested the second web page from the second web server using information on the first web page.

15. The method of claim 12, wherein the link class information is generated by the first web server based on a selection frequency of each of the links, which indicates how often client devices have requested other web pages by selecting each of the links contained in the first web page.

16. The method of claim 12, further comprising receiving the link class information from the first web server.

17. The method of claim 12, further comprising transmitting to the first web server path information indicating a path used before the client device accesses the first web server,
wherein the link class information is generated based on the path information.

18. The method of claim 12, wherein the link class information is generated by the client device analyzing a web page.

19. The method of claim 12, wherein the second web server provides a web page acquired through a link having the highest class in the link class information.

20. The method of claim 12, further comprising acquiring link class information indicating the preference of the client devices for links contained in the second web page.

21. The method of claim 12, further comprising receiving from the first web server the link class information, which has been received by the first web server from a web server providing an Internet portal site providing an information search service or from a link class management server collecting and managing class information of links to web servers.

22. The method of claim 12, wherein the receiving of the first web page from the first web server and the providing of the first web page further comprises displaying the first web page so that a predetermined number of links having a higher class in the link class information are distinguished from the remaining links contained in the first web page.

23. A computer readable recording medium storing a computer readable program for executing a method of prefetching a second web page via the Internet in a client device, the method comprising:
requesting the second web page provided by a second web server from the second web server, is the second web page being determined based on link class information indicating preference of client devices for links contained in the first web page provided by a first web server;
receiving the first web page from the first web server and providing the first web page; and
receiving the second web page from the second web server.
